(19) United States
(12) Patent Application Publication
(10) Pub. No.: US 2017/0094412 A1
(43) Pub. Date: Mar. 30, 2017

(54) WEARABLE RECORDING AND PLAYBACK SYSTEM

(71) Applicant: Eears LLC, Brooklyn, NY (US)

(72) Inventor: Anthony Mattana, Brooklyn, NY (US)

(21) Appl. No.: 14/870,502

(22) Filed: Sep. 30, 2015

(51) Int. Cl. H04R 5/04; H04R 5/033

(52) U.S. Cl. CPC H04R 5/04; H04R 5/033; H04R 5/0335; H04R 2205/024

(57) ABSTRACT

Systems and methods for capturing and reproducing a sound recoding are provided. In one embodiment, the sound recording is captured using a headphone set that includes a pair of ear cups, each including a housing, an artificial ear, a first microphone, and a transducer. The artificial ear is positioned within the housing and the first microphone is coupled to the artificial ear. The headphone set further includes a coupling member extending between the ear cups and a second microphone coupled to the coupling member.

### FIELD OF TECHNOLOGY

The present disclosure relates to a wearable recording and playback system with a headphone set equipped with microphones.

### BACKGROUND

Mobile audio recording devices typically use a single mono microphone to record sounds or a pair of coincident microphones that are centrally located. For portability, it may be desirable to reduce the size of such mobile audio recording devices. As the size of the mobile audio recording devices is reduced, however, the microphones may not record realistic sounds.

Binaural recording devices can record or capture sound using two microphones that are arranged as if each microphone were a human ear. The so-captured recording can be subsequently played back to reproduce ambient effects to the listener. For example, the binaural recording can produce a three-dimensional impression of sound.

Ambisonic recording devices can record or capture sound from more than three directions. The ambisonic recording devices can be programmed to produce any pickup pattern a directional recording device can. For example, ambisonic recording device can pick up a polarity pattern, such as omni-directional, cardioid, hypocardioid, supercardioid, hypercardioid, and figure-of-eight patterns.

### SUMMARY

According to one non-limiting aspect of the present disclosure, an example embodiment of a wearable recording and playback system is described. The example wearable recording and playback system includes a pair of ear cups, each ear cup including a housing, an artificial ear positioned within the housing, a first microphone coupled to the artificial ear, and a transducer coupled to the housing. The system further includes a coupling member extending between the pair of ear cups, a second microphone coupled to the coupling member, and at least one power supply electrically coupled to the first microphones, the transducers, and the second microphone.

According to another non-limiting aspect of the present disclosure, another example embodiment of the system is described. The example system includes a pair of ear cups, each ear cup including a housing, an artificial ear positioned within the housing, a first microphone coupled to the artificial ear, and a transducer coupled to the housing. The system further includes a coupling member extending between the pair of ear cups, a second microphone coupled to the coupling member, at least one wireless transceiver operatively coupled to the ear cups and the second microphone, and at least one power supply electrically coupled to the first microphones, the transducers, the second microphone, and the at least one wireless transceiver. The at least one wireless transceiver is adapted to wirelessly transmit and receive a signal.

According to another non-limiting aspect of the present disclosure, a method for creating a recording is provided. The method includes receiving a recording option via a recorder, the recording option selected from the group consisting of recording through a pair of first microphones, recording through a second microphone, and recording through both the first microphones and the second microphone, and executing a non-transitory device having instructions stored thereon that are configured to record ambient sound through the selected microphones. Each of a pair of ear cups includes at least one of the first microphones, and the second microphone is coupled to a coupling member extending between the pair of ear cups. At least one of the pair of ear cups includes at least one power supply electrically coupled to the pair of first microphones and the second microphone.

### BRIEF DESCRIPTION OF THE DRAWINGS

Features and advantages of the systems and headphone set described herein may be better understood by reference to the accompanying drawings in which:

FIG. 1 is a front view of a non-limiting embodiment of a headphone set according to the present disclosure, illustrating a pair of ear cups, a coupling member, and a second microphone on a user's head.

FIG. 2 is a side view of the headphone set of FIG. 1.

FIG. 3 is a top view of the headphone set of FIG. 1.

FIG. 4 is an exploded perspective view of the ear cup of FIG. 1, illustrating a housing, an artificial ear, a first microphone, a windscreen, and a ear pad.

FIG. 5 is an exploded perspective view of the ear cup of FIG. 1 from the opposite direction of FIG. 4, further illustrating a transducer.

FIG. 6 is a bottom view of the headphone set of FIG. 1, further illustrating a jack.

FIG. 7 is a schematic illustration of a non-limiting embodiment of a wearable recording and playback system according to the present disclosure.

FIG. 8 is an enlarged partial schematic illustration of the wearable recording and playback system of FIG. 7.

The reader will appreciate the foregoing details, as well as others, upon considering the following detailed description of certain non-limiting embodiments of systems and headphone set according to the present disclosure. The reader may also comprehend certain of such additional details upon using the systems and headphone set described herein.

### DETAILED DESCRIPTION

Smart devices, such as smartphones and tablets can be equipped with recording devices. Video/audio messaging applications running on the smart devices allow users to share personal audio and video files with other people through social media. However, current recording devices used with these smart devices may produce only a mono sound. Although there are many microphone options available, including binaural microphones and an ambisonic microphone, no solutions have been developed that easily work with these smart devices. Most of all, there are no recording devices that provide various recording options and that can be easily used with both smart devices and conventional recording devices.

The present disclosure, in part, is directed to recording and playback systems that provide various recording options, including a binaural recording and an ambisonic recording, and that can be easily used with both smart devices and conventional recording devices. The recording is captured using a headphone set that includes a pair of ear cups and a coupling member. Each ear cup includes a housing, an artificial ear positioned within the housing, a first microphone coupled to the artificial ear, and a transducer. The coupling member is extended between the pair of ear cups and coupled to a second microphone. In one non-limiting example, the systems are configured to enable users to selectively operate the first microphones, the transducers, and the second microphone. The sound that is captured by the first microphones and the second microphone can be acoustically identical to sounds captured by various types of microphones, such as, omni-directional, cardioid, hypocardioid, supercardioid, hypercardioid, figure-of-eight, binaural, and ambisonic microphones. Furthermore, a user can wear the headphone set on the user's head during recording, head tracking recording is possible under various recording options.

A “binaural recording” as used herein includes definitions that are generally known in the relevant art, and can refer to sound recorded or captured using two microphones that are arranged as if each microphone were a human ear.

An “ambisonic recording” as used herein includes definitions that are generally known in the relevant art, and can refer to sound recorded or captured using an ambisonic microphone.

An “ambient sound” as used herein includes definitions that are generally known in the relevant art, and can refer to the sound generated from a plurality of sources in the environment surrounding a user. For example, if the user is attending a concert, the ambient sound would be the music from the concert.

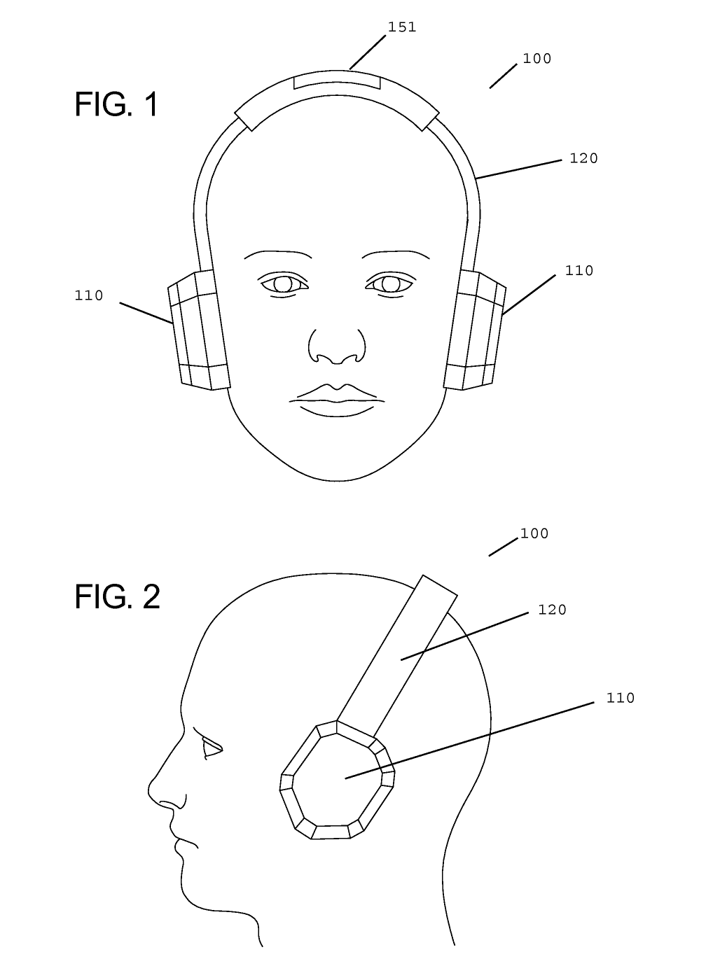

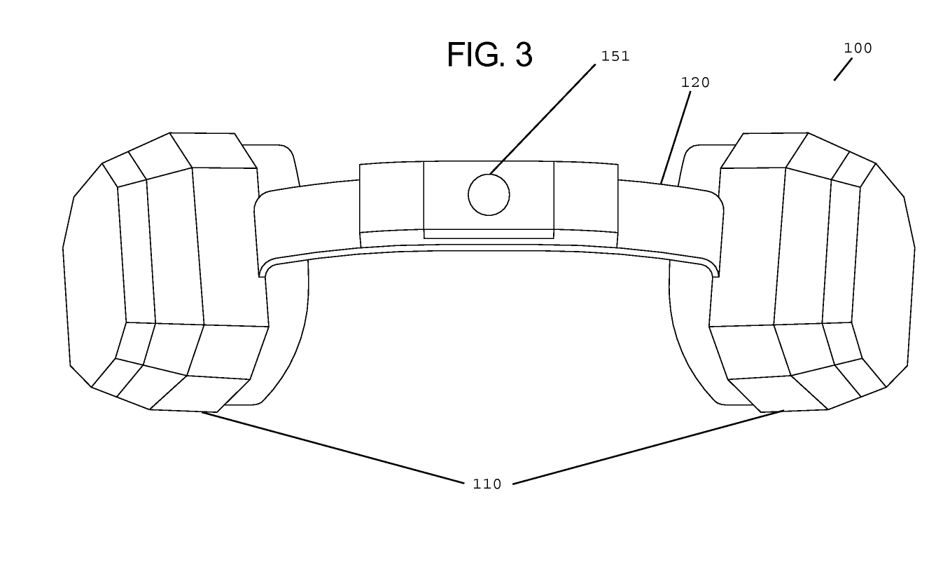

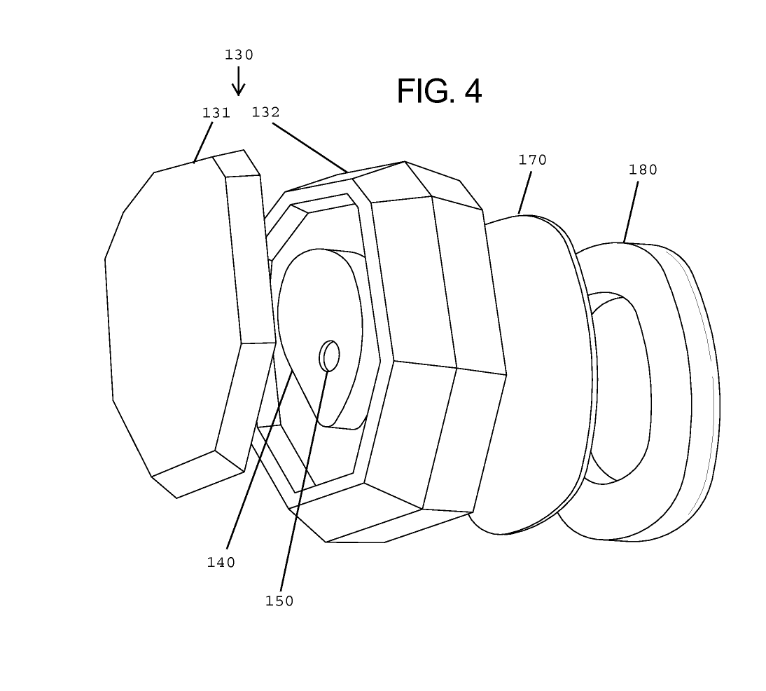

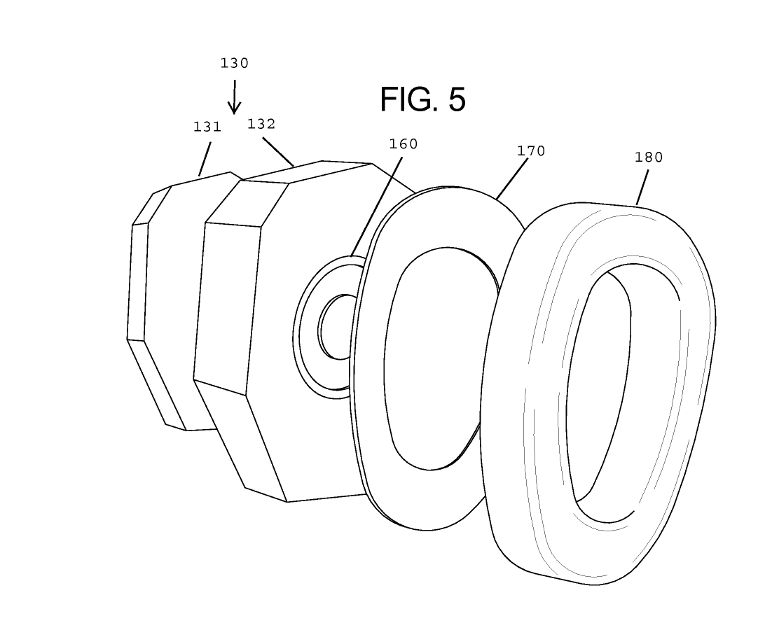

Referring to FIGS. 1-5, the illustrated headphone set 100 includes a pair of ear cups 110 and a coupling member 120. For the purpose of the description, the configuration of each ear cup 110 is generally the same, and will be described with reference to the illustrated ear cup 110 with the same effect as to the other ear cup. In certain non-limiting embodiments, the ear cup 110 can be made of plastic or similar light weight material allowing for comfortable wear by the user over the user's ear. In other embodiments, the ear cup 110 can be made of metal or similar strong material providing for enhanced strength and rigidity of the ear cup 110. In further embodiments, any material known in the art with similar characteristics can be used to produce the ear cup 110.

The ear cup 110 includes a housing 130, an artificial ear 140, a first microphone 150, and a transducer 160. In certain non-limiting embodiments, the housing 130 includes a housing cap 131 and a housing body 132. The housing 130 has a hollow interior space for holding other components, such as the artificial ear 140 and the first microphone 150.

The artificial ear 140 can be positioned within the housing 130. In certain non-limiting embodiments, the artificial ear 140 is in the shape of a human or animal ear. In further embodiments, the artificial ear 140 can be made of silicon, plastic, metal, or any other suitable material allowing for binaural recording. The artificial ear 140 may be removably coupled or attached to the housing 130. For example, the artificial ear 140 may be attached to the housing 130 via glue or friction.

The first microphone 150 is coupled to the artificial ear 140. In certain embodiments, the artificial ear 140 is proximate the user's ears so that the sound captured by the first microphone 150 is substantially acoustically identical to the one that would enter the user's ear. For example, by capturing this acoustically identical sound, the quality of the sound recording is enhanced to allow subsequent playback of the sound to be the same as if the person subsequently hearing the recorded sound had been present and in the same location as the original recording. The first microphone 150 can include any suitable electronic sound capturing devices. In certain embodiments, the first microphone 150 comprises a binaural microphone. For example, the pair of artificial ears 140 positioned within each ear cup 110 can act similar to a dummy head used for binaural recording.

In certain non-limiting embodiments, each first microphone 150 is fixedly coupled to the artificial ear 140. In other embodiments, however, the first microphone 150 can be removably coupled to the artificial ear 140, allowing for the removal and replacement of the first microphone 150.

The transducer 160 is coupled to the housing 130 and configured to reproduce an incoming sound signal. In certain non-limiting embodiments, the transducer 160 can be configured to receive electrical signals and transform the signals into sound waves or to receive sound waves and transform the sound waves into electrical signals. For example, the transducer 160 is configured to receive electrical signals and transform the signals into sound waves, thereby providing sound playback for the user. That is, the transducer 140 can be used for subsequent playback of sound that was originally recorded with the microphones disclosed here, as further explained below.

In certain non-limiting embodiments, a windscreen 170 covers the ear cup 110 to reduce wind noise. An ear pad 180 can be also attached to the ear cup 110 or the windscreen so as to substantially seal the user's ear. For example, sealing of the ear can be with respect to sound waves, allowing for optimal playback of recorded sound through the headphone set 100.

With continuing reference to FIGS. 1-3, the coupling member 120 is extended between the pair of ear cups 110 for holding the ear cups in position against the user's ears. In certain non-limiting embodiments, the coupling member 120 can be made of plastic or similar light weight material allowing for comfortable wear by the user over the user's head. In other embodiments, the coupling member 120 can be made of metal or similar strong material providing for enhanced strength and rigidity. In further embodiments, any material known in the art with similar characteristics can be used to produce the coupling member 120.

In certain non-limiting embodiments, the coupling member 120 is fixedly coupled to the ear cups 110. In other embodiments, however, the coupling member 120 can be removably coupled to the ear cups, allowing for the removal and replacement of the coupling member 120 with another coupling member. In further embodiments, the coupling member comprises an arced headband. In other embodiments, the coupling member comprises a biasing member (not shown) urging the pair of ear cups together.

The headphone set 100 further includes a second microphone 151 and the second microphone 151 is coupled to the coupling member 120. In certain embodiments, the second microphone 151 is fixedly coupled to the coupling member 120. In other embodiments, however, the second microphone 151 can be removably coupled to the coupling member 120, allowing for the removal and replacement of the second microphone 151. In certain non-limiting embodiments, the second microphone 151 can be disposed at a center of the coupling member 120 to capture sound in a 360 degree radius. However, in other embodiments, the second microphone 151 can be disposed at any other place on the coupling member 120. In certain non-limiting embodiments, the second microphone 151 can be an ambisonic microphone. According to certain non-limiting embodiments, B-format audio captured with the ambisonic microphone can be played back in virtual reality (“VR”) applications.

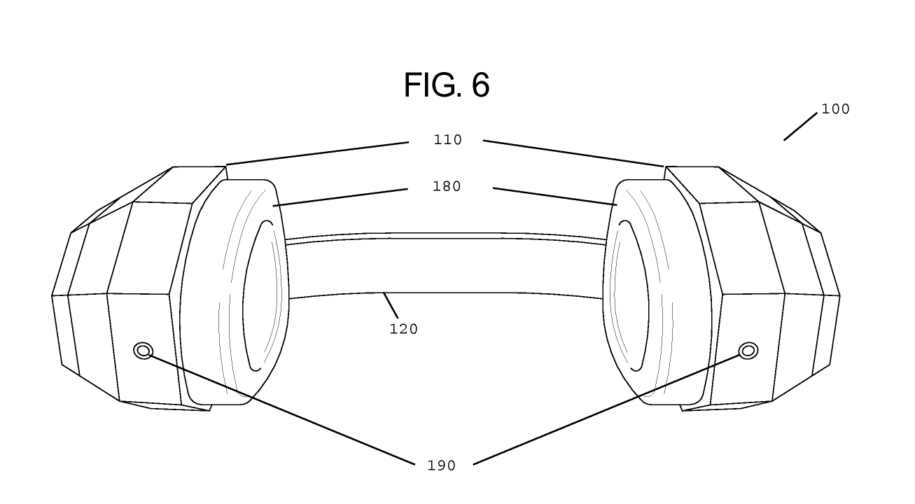

Referring to FIG. 6, in certain embodiments, at least one ear cup 110 includes a jack 190 for a wired recording and listening. For example, the ear cup 110 can include a 3.5-mm female jack that can connect to outside recording/playback devices via a male-to-male 3.5-mm stereo cable (not shown). In certain non-limiting embodiments, the ear cup 110 further includes a power switch (not shown), which enables a user to select between a wired recording and a wireless recording options. In further embodiments, the power switch further provides other recording options, for example, to select between recording through the first microphones and recording through the second microphone.

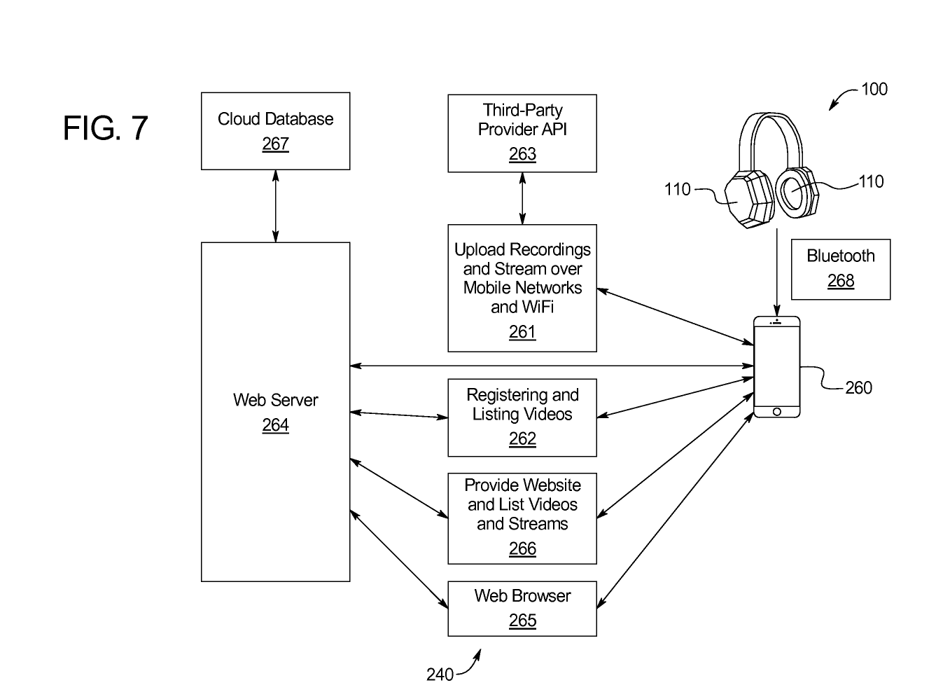

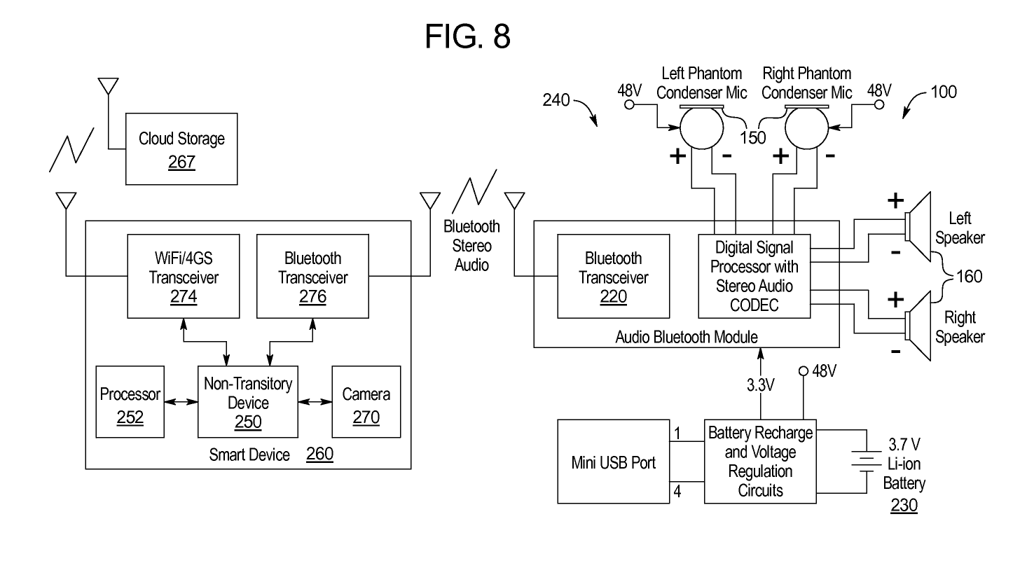

Referring to FIGS. 7 and 8, in certain embodiments, each ear cup 110 includes a wireless transceiver 220 coupled to the housing 130. In other embodiments, one ear cup 110 may include a wireless transceiver 220 coupled to the housing 130, and the other ear cup 110 may not include the wireless transceiver 220. The wireless transceiver 220 allows for two-way communication. In this regard, the wireless transceiver 220 is configured to transmit outgoing data representative of the sound captured by the first and second microphones 150, 151 and receive incoming data representative of the incoming sound signal. For example, the incoming and outgoing data can be sound signals stored for each stereo channel in a Waveform Audio File Format (“WAV”), an AC-3 format, an advanced audio coding (“AAC”) format, an MP3 format, or any other suitable audio file. In certain non-limiting embodiments, the outgoing data corresponds directly to the captured sound substantially without any augmentation or attenuation. However, in other embodiments, the outgoing data may be augmented, attenuated, or tuned.

In certain non-limiting embodiments, the transmitted data can also be configured to be other signals necessary for the connection and operation of the headphone set 100. For example, other transmitted data could include a wireless charging signal for the headphone set 100, or similar signals. In certain non-limiting embodiments, the wireless transceiver 220 can be configured to comply with existing transmission protocols such as a Bluetooth compatible protocol, IEEE 802.11 or similar short and medium range wireless transmission protocols. In other embodiments, the wireless transceiver 220 may use any other suitable form of short or medium range wireless communication. Although in the illustrated embodiment, the transceivers 220, 276 are indicated as Bluetooth transceivers, in other embodiments, the transceivers can be any other wireless transceivers.

In certain non-limiting embodiments, each ear cup 110 includes a power supply 230 electrically coupled to the respective first microphone 150, second microphone 151, transducer 160, and wireless transceiver 220. In other embodiments, one ear cup 110 may include a power supply 230 electrically coupled to the microphones 150, 151, transducers 160, and wireless transceiver 220, and the other ear cup may not include the power supply 230. In further embodiments, the wireless transceiver 220 and/or the power supply 230 can be positioned away from the ear cup 110, for example at the back of a user's head or in the coupling member 120, and shared with the ear cups 110.

In certain non-limiting embodiments, the power supply 230 can be a battery housed in a respective housing. A battery could be advantageous for the small, lightweight and portable aspects associated with a battery. In other embodiments, the power supply 230 may be attached or connected to the ear cup 110 outside a respective housing. For example, a cord (not shown) may attach the ear cup 110 to an external power supply 230. An external power supply 230 can be advantageous, as it allows for access to a larger power supply. In other embodiments, any other suitable power supplies known in the art may be used. In certain non-limiting embodiments, the coupling between the power supply 230 and the ear cup 110 is accomplished through wires connecting the components, circuitry or other similar electrical connections.

With continuing reference to FIGS. 7-8, in certain non-limiting embodiments, the wearable recording and playback system 240 includes a headphone set 100 and a non-transitory device or computing memory 250 operatively coupled to the headphone set 100. The non-transitory device 250 has instructions stored thereon that are configured when executed to selectively operate the first microphones 150, the second microphone 151, and the transducers 160 allowing for the recording and play back of sound signals. Although only the first microphones 150 are illustrated in FIG. 8, it should be noted that the first microphones are used only as an example and the second microphone 151 can be configured in the same way as the first microphones 150. In further embodiments, the non-transitory device 250 has further instructions thereon that are configured, when executed, to operate the second microphone 151 to selectively pick up a polarity pattern selected from the group consisting of omni-directional, cardioid, hypocardioid, supercardioid, hypercardioid, and figure-of-eight patterns. In other embodiments, the non-transitory device 250 has instructions for the headphone set 100 that includes start recording commands, stop recording commands, transfer commands, play commands, pause commands, stop commands, volume commands, and other control commands necessary for the operation of the headphone set 100. Although in the illustrated embodiment, the non-transitory device 250 is electrically coupled to the wireless transceivers 274, 276, the instructions can be executed via a wired connection through the jack(s) 190 on the ear cup(s) 110.

In certain non-limiting embodiments, the wearable recording and playback system 240 includes a recorder or receiving device 260 operatively coupled to the headphone set 100 and the non-transitory device 250, and a program stored on the non-transitory device 250, including instructions for recording the sound from the first and second microphones 150, 151 into a respective audio channel. The recorder 260 can be a smart device such as a smart phone, a smart eyewear, a smart watch, a tablet, a laptop, or any other electronic device, so long as it has a non-transitory device 250 and a processor 252. A cellular phone can be desirable when a user is interested in the portability of the system. On the other hand, a laptop can be desirable for the enhanced computing power, allowing for analysis and sharing of the electronic signals and larger storage capacity, which in turn can allow for higher quality and greater volume of storage.

In certain non-limiting embodiments, the wearable recording and playback system 240 includes a camera 270 operatively coupled to the non-transitory device 250 in addition to the headphone set 100 for recording. For example, the camera 270 can be any camera containing a 3.5-mm female stereo microphone jack, such as a GoPro® camera or any other suitable digital camera. As discussed above, the headphone set 100 can include a jack 190 that can connect to the camera 270 via a stereo cable (not shown). In another example, the camera 270 can be a three-dimensional stereoscopic imaging apparatus for realistically capturing or recording a video signal. The program stored on the non-transitory device 250 may match the video signal with the audio signal captured by the microphones and allow for the simultaneous playback, or combination of two signals into one stereo file. In certain non-limiting embodiments, The program stored on the non-transitory device 250 includes instructions to determine a command selected from the group consisting of recording only the sound captured by the headphone set 100, recording the sound and the video signal, live-streaming only the sound, and live-streaming the sound and the video signal.

In certain non-limiting embodiments, the wearable recording and playback system 240 uses an application programmable interface (“API”) to upload and/or stream recordings over mobile networks and Wi-Fi (block 261), and register and list audios and/or videos (block 262). In this regard, the recorder 260 can be used to communicate with a third-party provider API 263 and/or web servers 264 managed by respective entities. In certain non-limiting embodiments, a user can access the web server 264 via a web browser 265, and the web server 264 can provide a searchable web form or web page listing the audios and/or videos and streams (block 266) that are received from the recorder 260. The web server 264 can include a single server, or alternatively, can be distributed among multiple servers and/or within a cloud computing framework 267.

In certain non-limiting embodiments, the recorder 260 is configured to select between at least a recording mode and a playback mode, as well as provide for the collection and storage of data corresponding to at least sound recordings. In recording mode, a user can select a variety of recording options, including, but not limited to: recording via the pair of first microphones 150, recording via the second microphone 151, and recording via both the first microphones 150 and the second microphone 151, and recording with any of the microphones on the headphone set 100 and video with the recorder 260 camera. The selected recording option is determined via the processor 252. The creation of at least one recording using the headphone set 100 is then caused via the processor 252, and the wireless transceiver 220 can transmit electrical signals (see FIG. 7, block 268) from the headphone set 100 to the recorder 260 representative of sound signal.

In certain non-limiting embodiments, recordings can be emailed, shared with social media, saved in the library on the recorder 260. In further embodiments, a user can transmit the recordings to a third-party service provider (e.g., post to a Facebook® wall, pin to Pinterest®, or post to a Twitter, Instagram, or Tumblr account). In still further embodiments, a message server may be configured to parse notifications or alerts to notify or alert users of recordings in the form of instant messages, text messages (e.g., SMS, MMS), or web forum messages. The program can also allow users to upload, via a compatible transmission protocol such as Wi-Fi or 4G that may be included in the recorder 260, their recordings to their cloud storage or a similar networked data storage option.

If the user elects to stream, the program can connect to or activate a data network via a Wi-Fi or 4G transceiver 274 or Bluetooth transceiver 276 that may be included in the recorder 260, allowing for real-time, or substantially real-time, transmission of the live recording to anyone accessing the network with a compatible program on their own device. The program can stream either video, sound or a combination of both video and sound.

To utilize the playback capabilities, the user, while wearing the headphone set 100, opens the program on the recorder 260. The user then selects the music file or program to be played, and the recorder 260 sends a wired or wireless signal to the headphone set 100. The wireless transceiver 220 of the headphone set 100 can receive signals corresponding to musical playback from the recorder 260. If a wired connection is used, the signal can be directly sent to the ear cups 110 through the jack(s) 190 on the ear cup(s) 110. The transducer 160 can be used to transform an electric signal into a sound wave for playback of the sound signal being transmitted. The user can then listen to the file or program through the headphone set 100. In certain non-limiting embodiments, the non-transitory device 250 includes a pre installed head tracking audio engine for use with virtual reality (“VR”) video games or other VR devices like Occulus. According to certain non-limiting embodiments, B-format audio captured with an ambisonic microphone can be played back.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A wearable recording and playback system comprising:
a pair of ear cups, each ear cup comprising a housing, an artificial ear positioned within the housing, a first microphone coupled to the artificial ear, and a transducer coupled to the housing;
a coupling member extending between the pair of ear cups;
a second microphone coupled to the coupling member; and
at least one power supply electrically coupled to the first microphones, the transducers, and the second microphone.

2. The wearable recording and playback system of claim 1, wherein the first and second microphones are selected from the group consisting of a binaural microphone and an ambisonic microphone.

3. The wearable recording and playback system of claim 1, wherein the first microphones are each a binaural microphone and the second microphone is an ambisonic microphone.

4. The wearable recording and playback system of claim 1, wherein the coupling member comprises an arced headband.

5. The wearable recording and playback system of claim 4, wherein the second microphone is disposed at a center of the arced headband.

6. The wearable recording and playback system of claim 1 further comprising a non-transitory device operatively coupled to the ear cups and the coupling member, the non-transitory device having instructions thereon that are configured, when executed, to selectively operate the first microphones, the transducers, and the second microphone.

7. The wearable recording and playback system of claim 6, wherein the non-transitory device has further instructions thereon that are configured, when executed, to operate the second microphone to selectively pick up a polarity pattern selected from the group consisting of omni-directional, cardioid, hypocardioid, supercardioid, hypercardioid, and figure-of-eight.

8. The wearable recording and playback system of claim 6 comprising a recorder operatively coupled to the non-transitory device, wherein the non-transitory device has instructions stored thereon that are configured, when executed, to record sound from the first and second microphones into the recorder.

9. The wearable recording and playback system of claim 7, wherein the system is configured to pair a recorded sound to video data.

10. The wearable recording and playback system of claim 1, wherein the second microphone is electrically connected to the ear cups.

11. The wearable recording and playback system of claim 1, wherein the coupling member comprises a detachable arced headband.

12. A wearable recording and playback kit comprising:
the wearable recording and playback system of claim 11; and
a second detachable coupling member configured to be replaced with the detachable arced headband.

13. The wearable recording and playback kit of claim 12, wherein the second detachable coupling member comprises a biasing member urging the pair of ear cups together.

14. The wearable recording and playback system of claim 1, wherein the at least one power supply is housed in one of the ear cups.

15. The wearable recording and playback system of claim 1, wherein the artificial ear comprises silicone.

16. The wearable recording and playback system of claim 1, wherein the second microphone is detachable.

17. The wearable recording and playback system of claim 1, wherein the each ear cup further comprises a windscreen foam layer coupled to the housing.

18. A wearable recording and playback system comprising:
a pair of ear cups, each ear cup comprising a housing, an artificial ear positioned within the housing, a first microphone coupled to the artificial ear, and a transducer coupled to the housing;
a coupling member extending between the pair of ear cups;
a second microphone coupled to the coupling member;
at least one wireless transceiver operatively coupled to the ear cups and the second microphone, the at least one wireless transceiver adapted to wirelessly transmit and receive a signal; and
at least one power supply electrically coupled to the first microphones, the transducers, the second microphone, and the at least one wireless transceiver.

19. A wearable recording and playback system of claim 18, wherein the at least one wireless transceiver is disposed in one of the ear cups.

20. A wearable recording and playback system of claim 18, wherein the first and second microphones are selected from the group consisting of a binaural microphone and an ambisonic microphone.

21. A wearable recording and playback system of claim 18, wherein the coupling member comprises an arced headband.

22. A wearable recording and playback system of claim 18, wherein the second microphone is disposed at a center of the arced headband.

23. A wearable recording and playback system of claim 18 further comprising a non-transitory device operatively coupled to the ear cups, the coupling member, and the at least one wireless transceiver, the non-transitory device having instructions thereon that are configured, when executed, to selectively operate the first microphones, the transducers, and the second microphone.

24. The wearable recording and playback system of claim 23, wherein the non-transitory device has further instructions thereon that are configured, when executed, to operate the second microphone to selectively pick up a polarity pattern selected from the group consisting of omni-directional, cardioid, hypocardioid, supercardioid, hypercardioid, and figure-of-eight.

25. A wearable recording and playback system of claim 23 comprising a recorder operatively coupled to the non-transitory device, wherein the non-transitory device has instructions stored thereon that are configured, when executed, to record sound from the first and second microphones into the recorder.

26. A method for creating a recording, the method comprising:
receiving a recording option via a recorder, the recording option selected from the group consisting of recording through a pair of first microphones, recording through a second microphone, and recording through both the first microphones and the second microphone;
executing a non-transitory device having instructions stored thereon that are configured to record sound through the selected microphones,
wherein each of a pair of ear cups includes at least one of the first microphones, and the second microphone is coupled to a coupling member extending between the pair of ear cups, and
wherein at least one of the pair of ear cups includes at least one power supply electrically coupled to the pair of first microphones and the second microphone.
